(19) United States
(12) Patent Application Publication
(10) Pub. No.: US 2018/0049428 A1
(43) Pub. Date: Feb. 22, 2018

(54) LAMINATED GAME CALL

(71) Applicant: Gregory S. Burcham, Falkville, AL (US)

(72) Inventor: Gregory S. Burcham, Falkville, AL (US)

(73) Assignee: EBSCO Industries, Inc., Birmingham, AL (US)

(21) Appl. No.: 15/242,487

(22) Filed: Aug. 20, 2016

(51) Int. Cl. A01M 31/00

(52) U.S. Cl. CPC A01M 31/004

(57) ABSTRACT

An improved box-type game call having a conventional box and striker structure includes one or more laminate members affixed to the side walls of the call to enhance the sounding plates by providing a material different from the material of the side walls. The striker may also have an inset area that is made from a material other than the remainder of the striker or the remainder of the box call.

### FIELD OF INVENTION

This invention relates to a new type of friction call used for turkey hunting. Its construction involves a thin laminate member of man-made or organic material bonded to the working edge or one or both sides of a friction box call . . . .

### BACKGROUND

A box-type game call, typically a turkey call, generally includes a box including elongated sidewalls, opposing end walls connected to the ends of the elongated sidewalls, and a bottom, all made of wood. Box calls can be milled from solid blocks of wood or can be assembled from wood components. An actuator or striker, also made of wood, is pivotally mounted to one to the end walls such that it may be manipulated to rub across the upper edge of one of the side walls to produce a sound. Many variations are known, however, known competitive products use various grades and types of wood to produce proper sound quality. The quality and efficacy of such competitive products are limited to the quality of the wood and are at the mercy of any particular lot of wood stock available in constructing the box and striker.

### OBJECTS OF THE INVENTION

One of the objects of the present invention is to provide a box call that is capable of a reproducible call. In greater particularity, one object of the invention is to provide a box call whose material composition is less susceptible to variation and thereby more likely to reproduce the desired call with reliable efficiency. Yet another object of the invention is to make a box call that is water resistant such that the sounds can be more readily produced in rainy conditions.

### BRIEF DESCRIPTION OF THE DRAWINGS

Referring to the drawings which are appended hereto and which form a portion of this disclosure, it may be seen that:

FIG. 1 is perspective view of my improved

FIG. 2 is a second perspective view of my improved

FIG. 3 is a perspective view of the;

FIG. 4 is side view of the;

### DETAILED DESCRIPTION

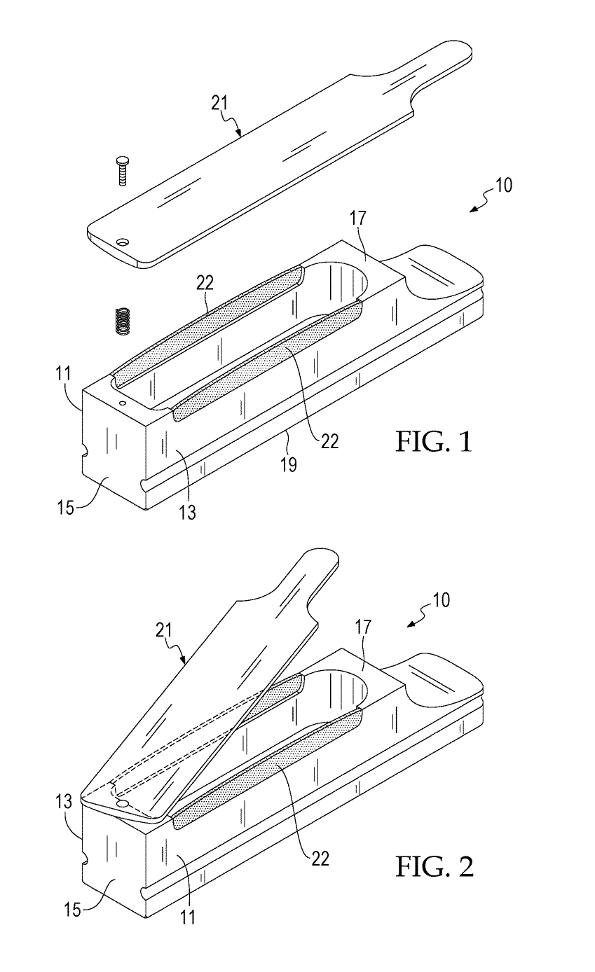

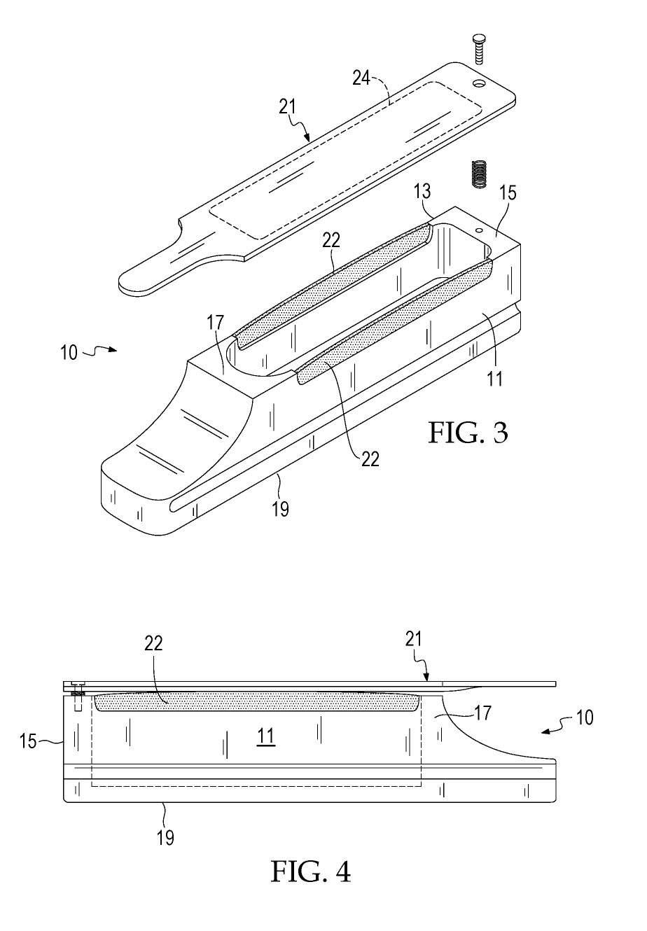

Referring to the FIGS. 1-4 for a clearer understanding of the invention, it may be seen that the preferred embodiment of the invention contemplates a box call 10 defined by a pair of longitudinal side walls 11 and 13, also called sounding plate, secured at each end to a pair of end blocks 15 and 17 and along their lower edges to a generally rectangular base plate 19. The construction and connection of the members thus described to one another may be of any conventional manner used in constructing box calls including milling the box from a single block of wood. Although wood is the preferred material for use in such calls, it is also possible to manufacture a box call from a manmade material such as an acrylic or other plastic. Likewise attached to one end block 15 of the call a spring loaded striker plate 21 is mounted to selectively engage the upper edge of walls 11 or 13 at the urging of the user. In the preferred embodiment the striker plate 21 is also made of wood.

Because wood varies in quality from lot to lot and because wood changes its tonal properties when wet, we have elected to attach a sounding laminate member 22 onto the box call side walls 11 and 13. The laminate member 22 may be formed on either or both sidewalls and may be made from the same or a dissimilar material. By way of example, the box may be initially made from one type wood and the laminate member 22 may be of a different wood which is less susceptible to variation in tone and less affected by moisture. In addition to wood, the materials that may be used as the laminate member 22 include stainless steel, iron, brass, copper, aluminum, magnesium, titanium, solid surface materials such as Corian®, slate, ceramic, polycarbonate, acrylic, all rigid man made polymers, glass, crystal, fiber glass, para-aramid synthetic fiber such as Kevlar®, and carbon fiber materials. When laminated these materials onto the working edge of a wood box call by varying the width and thickness of the laminate member 22, we can control the sound quality. Not only does this provide the desired contact surfaces, but by varying the width and thickness of the laminate member 22, it is possible to control the sound quality.

The laminate member 22 is inlaid into the side walls 11 and 13 such that the laminate member extends slightly above the top of the sidewalls 11, 13 and is therefore contacted by the striker plate 21 to create the yelps and purrs depending on the skill of the user.

In yet another embodiment the box call 10 is made from a man-made material and may not have the inherent sound qualities of a wooden box call. In this embodiment the laminate member 22 does have the desired tonal qualities and the man made material has to be selected to as to enhance the qualities. For example, soft plastic would tend to deaden or mute the vibrations induced in the laminate member, whereas a rigid man made material would not do so, thus certain acrylic or ceramic materials may serve as a box onto which the laminate member 22 may be inlaid. Likewise, the striker plate 21 may be of a similar man-made material with a wood or other material inlay 24 secured thereto such that the chosen materials can be brought into contact to create the yelps and purrs.

While in the foregoing specification this invention has been described in relation to certain embodiments thereof, and many details have been put forth for the purpose of illustration, it will be apparent to those skilled in the art that the invention is susceptible to additional embodiments and that certain of the details described herein can be varied considerably without departing from the basic principles of the invention.

What we claim is:

1. A game call including a box by opposing side walls connected to opposing end members with a pivotally mounted striker secured to one end member wherein the improvement comprises: at least one laminate member affixed to at least one of said opposing side walls in position to be selectively engaged by said pivotally mounted striker to create sounds in the nature of yelps and purrs said laminate member being selected from a material different from said side walls.

2. A game call as claimed in claim 1 wherein said at least one laminate member is a man-made material.

3. A game call as claimed in claim 1 wherein said at least one laminate member made from a material selected from the group consisting of: wood, stainless steel, iron, brass, copper, aluminum, magnesium, titanium, solid surface materials, slate, ceramic, polycarbonate, acrylic, all rigid man made polymers, glass, crystal, fiber glass, para-aramid synthetic fiber, and carbon fiber.

4. A game call as defined in claim 1 wherein said box is made from wood and said at least one laminate member is made from a different type of wood.

5. A game call as defined in claim 1 wherein said box is made from wood and said at least one laminate member is made from a material selected from the group consisting of: wood differing from the box, stainless steel, iron, brass, copper, aluminum, magnesium, titanium, solid surface materials, slate, ceramic, polycarbonate, acrylic, all rigid man made polymers, glass, crystal, fiber glass, para-aramid synthetic fiber, and carbon fiber.

6. A game call as defined in claim 1 wherein said at least one laminate member is affixed to a working edge of said at least one side wall.

7. A game call as defined in claim 1 wherein said at least one laminate member extends above said at least one side wall for engagement with said striker.

8. A game call as defined in claim 1 wherein said box is made from a man-made material.

9. A game call as defined in claim 8 wherein said at least one laminate member is made from wood.

10. A game call as defined in claim 8 wherein said at least one laminate member is selected from the group consisting of: wood, stainless steel, iron, brass, copper, aluminum, magnesium, titanium, solid surface materials, slate, ceramic, polycarbonate, acrylic, all rigid man made polymers, glass, crystal, fiber glass, para-aramid synthetic fiber, and carbon fiber.

11. A game call as defined in claim 8 wherein said pivotally mounted striker has an inset member positioned to engage said at least one laminate member, said inset member selected from the group consisting of: wood, stainless steel, iron, brass, copper, aluminum, magnesium, titanium, solid surface materials, slate, ceramic, polycarbonate, acrylic, all rigid man made polymers, glass, crystal, fiber glass, para-aramid synthetic fiber, and carbon fiber.

12. A game call as defined in claim 1 wherein said pivotally mounted striker has an inset member positioned to engage said at least one laminate member, said inset member selected from the group consisting of: wood, stainless steel, iron, brass, copper, aluminum, magnesium, titanium, solid surface materials, slate, ceramic, polycarbonate, acrylic, all rigid man made polymers, glass, crystal, fiber glass, para-aramid synthetic fiber, and carbon fiber.
